(19) United States
(12) Patent Application Publication
(10) Pub. No.: US 2005/0050874 A1
(43) Pub. Date: Mar. 10, 2005

(54) Windrow machine and harvesting method

(76) Inventor: Horacio Alberto Pailhe, Buenos Aires (AR)

Correspondence Address: MERCHANT & GOULD PC, P.O. BOX 2903, MINNEAPOLIS, MN, 55402-0903, US

(21) Appl. No.: 10/901,564

(22) Filed: Jul. 29, 2004

(30) Foreign Application Priority Data
Sep. 5, 2003 (AR) P 03 01 03229

(51) Int. Cl. A01D 57/26

(52) U.S. Cl. 56/192

(57) ABSTRACT

A farming windrow machine and method for sowing a second crop before the first crop is harvested. The windrow machine is preferably hitched to a tractor and is followed by an agricultural machine to sow a field immediately after the crop nearly ready for harvested is cut. The machine omprises a frame supporting means for aligning crop upstanding in the field and mower means for cutting the aligned crop. The machine further comprises a conveyor belt mounted on a pair of spaced rollers, the conveyor belt cantilevered over a side of the windrow machine for transporting and piling the cut crop over and away from one side of the machine, such that a sower machine may follow the windrow machine to sow a second crop in the wake of the first cut crop, thereby increasing crop cultivation days and improving farm turnover.

### FIELD OF THE INVENTION

The present invention generally refers to no or low irrigation farming; in particular to an agricultural windrow machine and to a method for sowing a secondary (e.g. summer) crop before a primary (e.g. winter) crop is harvested. The invention further refers to the use of a tandem comprising a grain sower machine useful for sowing the secondary crop grouped with a windrower for harvesting a primary crop.

World population is permanently on the increase; food production should increase in order to combat malnutrition and enable developing countries to have access to decent feeding of its next generations. The present invention addresses the problem of improving farming productivity.

### BRIEF DESCRIPTION OF THE PRIOR ART

In the last few years, several techniques have been developed in the world for optimizing farm yield. One such pioneering technique is the so-called direct sowing system. The direct sowing technique basically consists in planting seeds without first ploughing the field, thereby reducing time-frames for sowing. Costs thereof are reduced at the same time, thereby lowering grain prices.

The onset of the direct sowing technique has positively impacted growing secondary crops. An interesting future has opened up in secondary crop production with the acceptance of Roundup Resistent™ soya (alround herbicide coverage). Secondary crops have been widely accepted worldwide because of their good adaptability to different regions.

This practice has given rise to intersowing, consisting in sowing and harvesting a winter crop (alias the primary or predecessor crop) in the pertinent season as usual and, after harvesting the winter crop at the onset of summer, sowing a summer crop (alias the secondary crop). The summer crop (e.g. soya) is necessarily sown late, that is about a fortnight after its optimal sowing date.

Several studies have shown that if a crop is not sown on its optimal sowing date, its yield declines for every day late, depending on the type and variety of the crop and the type of land. In the Southern hemisphere (specifically in the Argentine pampa region), soya harvest may drop dramatically if it is sown after 1st December (seasonally equivalent to 1st June in the Northern hemisphere). Research shows that harvest yield may drop between 15 and 25 kilogrammes/hectare for each day sowing is delayed at the beginning of December, rising up to between 50 and 60 kilogrammes/hectare per day of delay by the end of December.

Therefore, a problem with secondary crops is that they are sowed late relative to their optimal sowing date such that the maximum yield potential thereof may not be realized. Considering the loss of profits due to late sowing of the secondary crop, ways for anticipating sowing the secondary crop have been looked for, for making secondary crops more profitable.

For example, using a predecessor crop that can be harvested earlier without substantially affecting yield. For example, colza which frees the land earlier than grains.

In relation to agricultural machinery, windrow machines set the mowed crop aside in rows for later harvesting. For example, Argentine patent AR 202,225 discloses a self-powered windrow machine comprising a reciprocating comb-type cutter, a forward longitudinally-positioned conveyor belt for lifting the mowed crop onto a rear conveyor belt extending across the full width of the machine and sticking out to one side for dumping the mowed crop on that side. Neither the above-mentioned machine nor other machines on the market provide for a sowing machine to follow behind such that the winter crop is left in piles to be harvested.

U.S. Pat. N0. 6,145,289 discloses a windrow arrangement including a crop conveyor attached to the main frame of a mower for harvesting crop. The conveyor intercepts just cut crop from the mower and discharges it either sideways or backwards into a windrow forming structure. There is no suggestion of inserting a sowing machine into this arrangement, rather U.S. Pat. No. 6,145,289 teaches towards a cascade arrangement of two or more, say three, mower machines to operate alongside each other to deposit a like number of windrows to be subsequently picked up together for processing by an ensilage harvester or the like.

### SUMMARY OF THE INVENTION

Therefore, an object of the present invention is to provide a farming method wherein a second crop may be sowed around its optimum date without affecting the yield of a first crop grown on the same plot of land.

Another object of the invention is to increase the cultivation time of a second crop in a field used for normally cultivating a first crop.

A further object of the invention is to eliminate idle time between harvesting a first crop and sowing a second crop, thereby improving farming efficiency.

The present invention basically provides a farming method wherein a second crop is sowed before a first crop on the same plot of land is harvested. It is based on the discovery that once the grain of the first crop is physiologically mature, i.e. containing about 35% of moisture, 10 to 15 days before reaching its normal harvest moisture, the crop may be cut since the grain is full and this does not affect the weight of the seed nor its germinating potential.

The method of the invention basically comprises in bringing the sowing date of a second crop forward towards its optimal sowing date by sowing the second crop in a field before a first crop has been harvested, by moving a windrow machine along a predetermined path through and cutting or mowing the first crop and a sowing machine for sowing a second crop a short distance behind said windrow machine, following the same predetermined path. The cut first crop is dumped by the windrow machine, on a part of the path already traveled by both machines.

The first crop is left to dry in rows on the ground on top of where seeds of the second crop have already been sown and harvested several days later. The number of days the first or primary crop is left to dry while the second crop germinates and begins to sprout is the minimum cultivation time gained by the second crop at no expense to the first crop, in terms of yield. Another advantage is that the second crop may be sown on land having no residue from the first crop such that the seed-earth contact is good, thereby reaping the cost benefits of the direct sowing system.

A further object of the present invention is to provide a farming windrow machine for coupling with several kinds of agricultural machines for sowing fields before harvesting. The machine of the invention is of the type including a chassis, turnstile means for aligning the crop, a cutter for cutting the aligned crop and at least one conveyor means for the cut crop, wherein the nominal length of the conveyor means is not less than the width of the chassis of the machine so as to dump the conveyed cut crop to one side of the machine.

### BRIEF DESCRIPTION OF THE DRAWINGS

FIG. 1 is a perspective view of a windrow machine according to the present invention.

FIG. 2 is a longitudinal section of the front mower-conveyor portion of the windrow machine of FIG. 1.

FIG. 3 is a plan schematic of a field illustrating the practice of the interharvest-sowing method of the present invention using the windrow machine of FIG. 1.

### DETAILED DESCRIPTION OF A PREFERRED EMBODIMENT

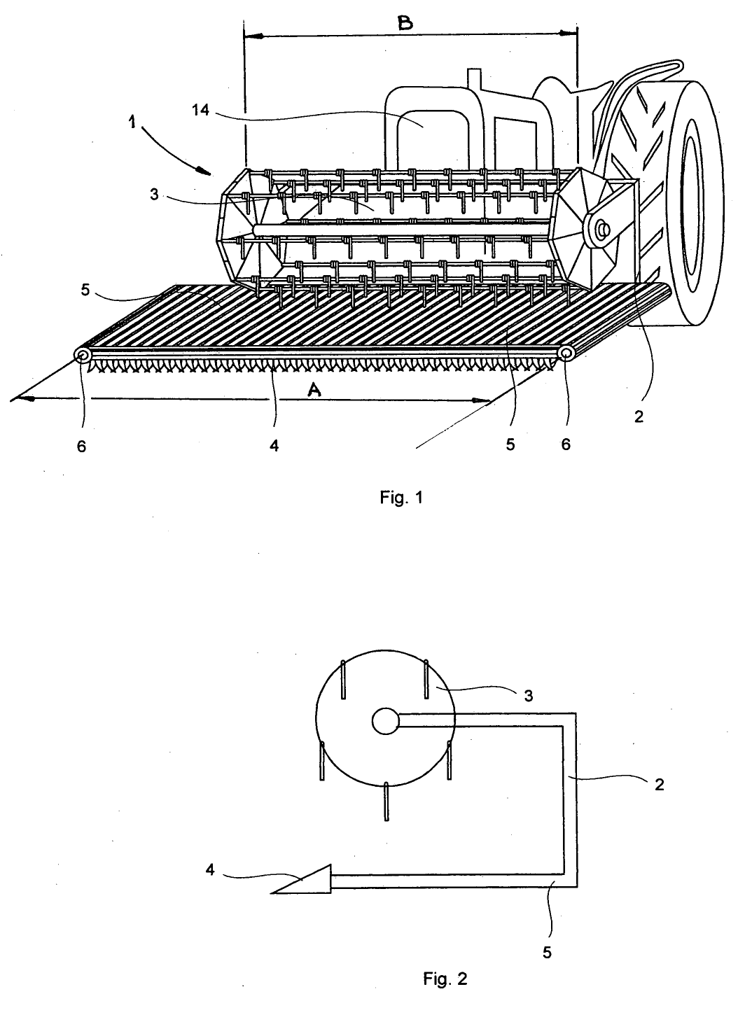

Referring now to FIG. 1, a swather or windrow machine 1 according to the present invention is hitched to the front of a tractor 14 to be drivwn over a field of crops. As also shown in FIG. 2, the windrow machine 1 comprises a main chassis 2 supporting a mower or cutter device 4 for cutting crop in front of the windrower and dumping cut crop on a platform 5. A retractile, variable-speed turnstile 3 aligns the crop on the platform 5. The platform essentially comprises at least one conveyor device, such as a belt 5, an endless screw or other means suitable for conveying the cut crop forming rows to one side of the machine 1.

A pair of rollers 6 support and drive the conveyor belt 5. As shown in FIG. 1, the rollers 6 are separated by a distance A substantially not less than the width B of the chassis 2. This makes the length of the operational surface of the conveyor belt such that the machine 1 generates rows of cut crop to one side, away from the path traveled by the machine 1.

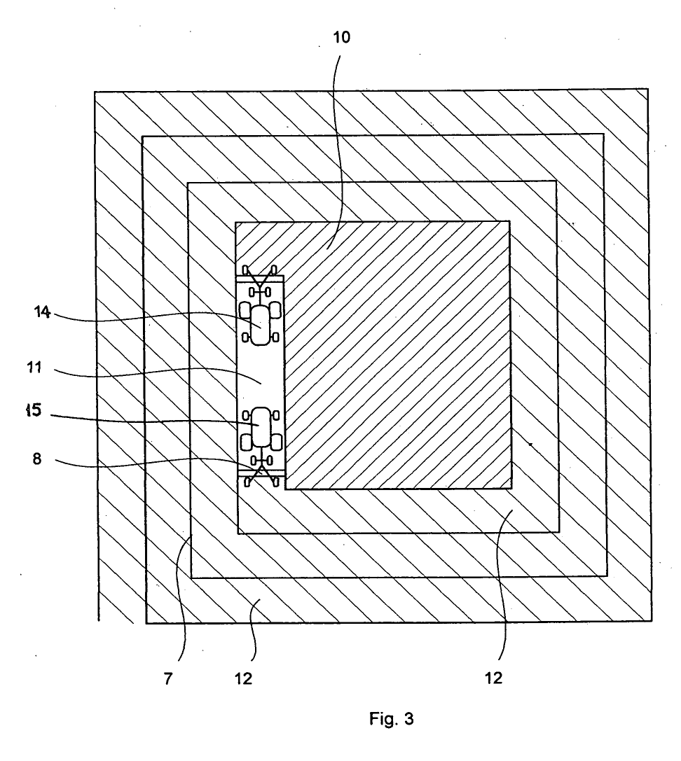

FIG. 3 is a schematic showing the method of sowing before harvesting according to the present invention using the windrow machine 1 and a sowing machine 8. According to this method, the windrow machine 1 cuts the upstanding crop 10 and generates a row 7 by means of the conveyor belt 5 to one side of the windrower 1. At the same time, the sowing machine 8 follows behind sowing seeds in the wake of the windrow machine 1. The sowing machine 8 may suitably be the same fine-grain sower-machine used for sowing the winter crop and be hitched to the same tractor 14 as the windrower 1 or to another tractor 15 or have its own propulsion means.

The nominal width B of the windrow machine 1 may vary according to the width of the sower machine 8. Distance A may be 23 feet and width B 15 feet in a typical windrow set-up, i.e. an A:B ratio of about 3:2. The rollers 6 may reverse the direction of the conveyor belt 5 according to which way a field is harvested.

The windrower-sower tandem 1-8 may travel along a generally rectangular spiral path, or the like, covering the cultivated surface of the field. The windrow machine 1 generates a region 11 of cut crop over which the sowing machine 8 passes directly over, right behind the windrow machine 1. The sowing machine 8 sows this freed region of land 11 left behind the windrow machine 1, thereby generating a sown region of land 12. Each time round, the row 7 is continued by the windrow machine on top of the land sown in the previous turn.

The row 7 is thus formed at one end of the conveyor belt 5, on land previously sown and where it does not interfere in the path of a sowing machine 8 following behind the windrower 1, thereby enabling the farmland plot to be sowed with a new crop before the old crop is harvested.

Hence, the sowing method of the present invention using the windrow machine 1 enables the farmer to bring forward the sowing of a fresh crop before the older crop has dried in the rows 7. For example, soya, sunflower, wheat, etc. may be sowed at an earlier date than heretofore using the method and machines 1 and 8 of the present invention, such that the summer crop is already germinating or near to sprouting when the winter crop is harvested.

A further advantage derived from the use of the windrow machine 1 and the method of the present invention is the elimination of dead time-spans between cutting the first crop into rows and sowing the next crop, thereby eliminating idle personnel and machinery time on farming estates, thereby optimizing farming efficiency.

### EXAMPLES

### Example 1

Primary crop: Colza, Secondary Crop: Soya.

The primary crop is harvested on 30/11 and the secondary crop on 25/4 of the following year. Hence, under the conventional system, the cultivation time of the secondary crop would be 146 days. Using the system of the invention, the colza may be cut and the soya sown on 20/11, thereby extending the latter's cultivation time by 10 days at least. Estimated yield increase: 300 Kg/Ha.

### Example 2

Primary Crop: Barley, Secondary Crop: Soya.

The primary crop is harvested on 14/12 and the secondary crop on 2/5 of the following year. Hence, under the conventional system, the cultivation time of the secondary crop would be 139 days. Using the system of the invention, the barley may be cut and the soya sown on 7/12, thereby extending the latter's cultivation time by 7 days at least. The barley may be harvested on 12/12. Estimated yield increase: 280 Kg/Ha.

### Example 3

Primary Crop: Maize, Secondary Crop: Soya.

The primary crop is harvested on 26/12 and the secondary crop on 10/5 of the following year. Hence, under the conventional system, the cultivation time of the secondary crop would be 135 days. Using the system of the invention, the maize may be cut and the soya sown on 18/12, thereby extending the latter's cultivation time by 8 days at least. The maize may be harvested on 24/12. Estimated yield increase: 400 Kg/Ha.

N.B.: The dates correspond to Southern hemisphere seasons.

While the invention has been described with reference to preferred embodiments, it will be understood by those skilled in the art that various changes can be made to adapt a particular situation or step to the teachings of the invention and equivalents can be substituted for elements thereof within the purview of the appended claims. For instance, although the embodiment describes two machines 1 and 8 traveling in a tandem, the forward machine 1 generating rows of the first crop to one side, it is foreseeable to integrate the windrower and sowing functions into a single machine and dump rows of the cut first crop behind the land just sowed, by conveying the first crop cut at the forward part of the integrated machine to the back thereof and suitably embodying sower macninery in an intermediate part of the machine.

1. A method for sowing a second crop before harvesting a first crop on the same land, said method comprising the steps of:
cutting said first crop,
sowing said second crop is sown where the first crop has been cut,
dumping and leaving the first crop to dry on the land where the second crop was sown and
harvesting the first crop after it has substantially dried and before the second crop sprouts from the land.

2. In a field containing a first crop to be harvested, a method for sowing a second crop before harvesting said first crop, said method comprising the steps of:
dividing said field into a predetermined sequential, generally side-by-side strips of land containing;
cutting said first crop along a predetermined path substantially covering at least a part of said field to be harvested;
sowing a second crop on the land from which said first crop was cut, substantially following said predetermined path; and
dumping the first crop just cut onto the land already sown with said second crop.

3. A method according to claim 2, wherein said first crop is dumped to one side of the path from where it was cut.

4. A method according to claim 2, wherein said path follows a generally rectified spiral shape.

5. A method according to claim 2, further comprising the step of harvesting said first cut crop dumped on top of the land sown with seeds of the second crop after said dumped cut first crop has substantially dried and before said second crop substantially sprouts.

6. A method according to claim 1, wherein said first crop harvesting step is carried out between ten and fifteen days after the first crop was cut and said second crop sown.

7. A method according to claim 1, wherein said steps comprise:
dividing said field into a predetermined sequential, generally side-by-side strips of land containing said first crop;
moving a windrow machine along said predetermined strips, one at the time in sequence, cutting the first crop along the strip being traveled by the windrow machine;
moving a sowing machine along said predetermined strips behind said windrow machine to sow said second crop in the strip of land just cut of said first crop;
dumping from said windrow machine the first crop just harvested in a said strip of land to a side of the strip being cut and which has already been cut with said first crop and sowed with said second crop.

8. A method according to claim 7, wherein said sequence of strips of land generally form a rectangular spiral shape.

9. A method according to claim 7, wherein said dumping step is carried out on the strip of land immediately adjacent the strip being harvested and sowed.

10. A windrow machine for use in a method for harvesting and sowing according to claim 1, said windrow machine including sides defining a machine width therebetween, said windrow machine adapted for traveling over a field in a forward direction generally parallel to said machine sides, said windrow machine further comprising:
means for cutting crop upstanding in the field and means for receiving said cut crop and dumping it at a distance away from one side of said windrow machine.

11. A windrow machine according to claim 10, wherein said cut crop receiving and dumping means comprises a conveyor belt mounted across said machine forward traveling direction, said conveyor belt substantially projecting from at least one side of said windrow machine.

12. A windrow machine according to claim 11, wherein said conveyor belt projects about one-half of said width of the windrow machine over each or at least one of said machine sides.

13. A windrow machine according to claim 11, wherein said conveyor belt projects substantially less than one-half of said width of the windrow machine over each or at least one of said machine sides.

14. A method according to claim 2, wherein said steps comprise:
dividing said field into a predetermined sequential, generally side-by-side strips of land containing said first crop;
moving a windrow machine along said predetermined strips, one at the time in sequence, cutting the first crop along the strip being traveled by the windrow machine;
moving a sowing machine along said predetermined strips behind said windrow machine to sow said second crop in the strip of land just cut of said first crop;
dumping from said windrow machine the first crop just harvested in a said strip of land to a side of the strip being cut and which has already been cut with said first crop and sowed with said second crop.

15. A windrow machine for use in a method for harvesting and sowing according to claim 2, said windrow machine including sides defining a machine width therebetween, said windrow machine adapted for traveling over a field in a forward direction generally parallel to said machine sides, said windrow machine further comprising:
means for cutting crop upstanding in the field and means for receiving said cut crop and dumping it at a distance away from one side of said windrow machine.
